(19) United States
(12) Patent Application Publication
(10) Pub. No.: US 2024/0425389 A1
(43) Pub. Date: Dec. 26, 2024

(54) WATER TREATMENT SYSTEM AND WATER TREATMENT METHOD

(71) Applicant: D2D Water Solutions B.V., Ede (NL)

(72) Inventor: Ton VAN HECKE, Halle (NL)

(21) Appl. No.: 18/708,270

(22) PCT Filed: Nov. 11, 2022
(86) PCT No.: PCT/NL2022/050646

§ 371 Date: May 8, 2024

(30) Foreign Application Priority Data
Nov. 11, 2021 (NL) 2029718

(51) Int. Cl. C02F 1/44; C02F 1/32; C02F 1/68; C02F 103/00

(52) U.S. Cl. CPC C02F 1/444; C02F 1/32; C02F 1/685; C02F 2103/001; C02F 2201/005; C02F 2209/03

(57) ABSTRACT

Residential water treatment system, including: —a rain water collector (1), a water treatment unit (9), and a pump (2) for pumping water from the rain water collector (1) to the water treatment unit (9) via a water duct (8), wherein the water treatment unit (9) includes: an ultrafiltration unit (10) including a filtering space (12), a water collecting space (13) and a downstream filtered mf) water outlet (14), the filtering space (12) and collecting space (13) being separated by a porous wall (4), wherein the filtering space (12) extends between a water inlet port (11) and a water outlet port (15), in particular for supplying water to the filtering space during a water filtering phase and for flushing the filtering space during a flushing phase; wherein the system is configured for feeding flushing water from the filtering space (12) to the rain water collector (1) during a filter flushing phase.

The present invention relates to a water treatment system, in particular a residential system, for providing drinking water (i.e. water safe for human consumption) from rain water.

Such water treatment systems are known from the prior art. Generally, known water treatment systems include a rain water collector (e.g. a buffer tank), a pump for pumping the rain water to local end users and one or more filters for filtering the rain water. Known systems are relatively complex, centralized, require a fairly large location to function, require much maintenance and can be energy-inefficient.

The present invention aims to provide an improved water treatment system and water treatment method. In particular, the invention aims to provide a system that requires relatively little maintenance, that can treat the rain water efficiently and effectively (preferably such that the treated water is safe for human consumption), and preferably such that the system can operate reliably for long operational periods (for example at least 10 years).

According to an aspect of the invention, to this aim a system is provided that is characterized by the features of claim 1.

Advantageously, a system is provided that includes a rain water collector a water treatment unit and a pump (for pumping water from the rain water collector to the water treatment unit via a water duct, wherein the water treatment unit includes:
an ultrafiltration unit including a filtering space, a water collecting space and a downstream filtered water outlet, the filtering space and collecting space being separated by a porous wall, wherein the filtering space extends between a water inlet port and a water outlet port, in particular for supplying water to the filtering space during a water filtering phase and for flushing the filtering space during a flushing phase;
   wherein the system is configured for feeding flushing water from the filtering space to the rain water collector during a filter flushing phase.

In this way a reliable and preferably circular, decentralized rain water treatment system can be provided. Since flushing water can be returned to the rain water collector (instead to a drain, e.g. a sewer system), the flushing does not lead to substantial loss of water, so that relatively long and thorough filter flushing can be achieved without wastage. Also, in this way, reliable system operation can be achieved (i.e. during normal use, when the system can generate filtered water). Since the system includes an ultrafiltration unit, high filtering performance can be achieved, and bacteria-free filtered water can be delivered (i.e. as drinking water quality which is fit for human consumption as determined by law). Bacteria that have been filtered can simply be returned back to the rain water collector during a filter flushing phase.

Further, an aspect of the invention provides a water treatment unit of a system according to the invention, wherein the water treatment unit is including in an assembled structure, for example having a carrier frame and/or housing, the structure preferably also including at least at least one water treatment device for treating the flushing water. In this way, the water treatment unit can be delivered, installed and/or mounted in a straight-forward (‘plug & play”) manner at a desired location, e.g. near an end user and/or a rain water collector or water duct leading from the rain water collector.

Furthermore, an aspect of the invention includes a compact assembly of the water treatment system inside a suitable structure, such as a carrier frame and/or housing. The structure preferably also includes at least one water treatment device for treating the flushing water.

Further, an aspect of the invention provides an improved method for treating rain water, the method for example including utilizing a system according to the invention. The system can e.g. include multiple filters working in synergy.

The method includes:
collecting rain water, in a rain water collector;
filtering collected rain water, by one or several filters, including e.g. an ultrafiltration unit, during a water filtering phase;
flushing the one or several filters with flushing water during a flushing phase;
feeding the flushing water to the rain water collector.

In this way, the above-mentioned advantages can be achieved.

In the following, the invention will be explained further using exemplary embodiments and drawings. The drawings are schematic and merely show examples. In the drawings, similar or corresponding elements have been provided with similar or corresponding reference signs. In the drawings:

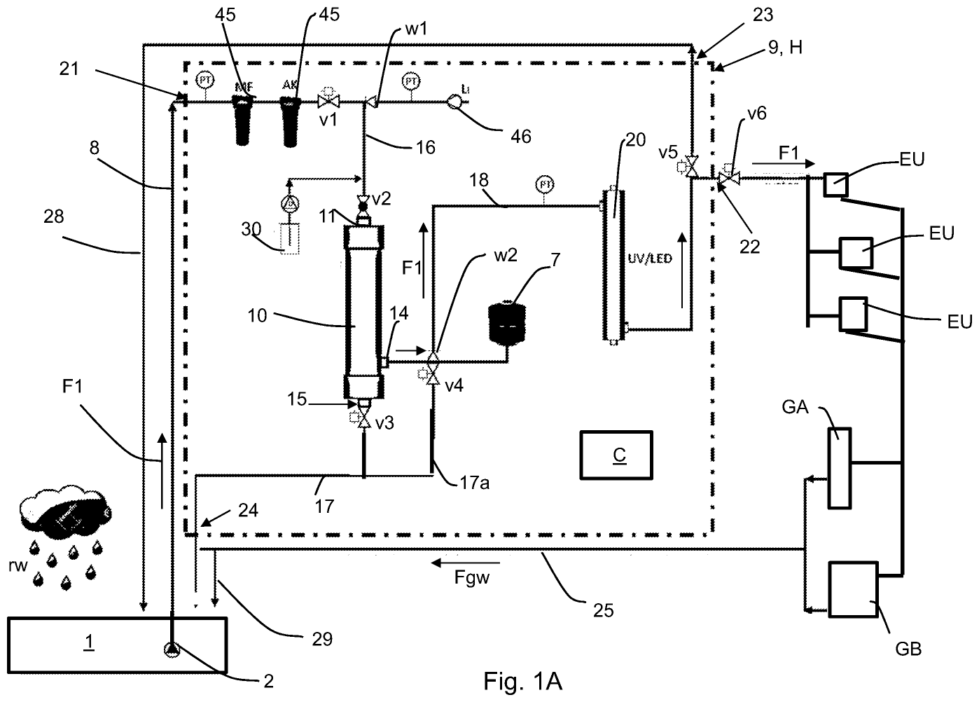

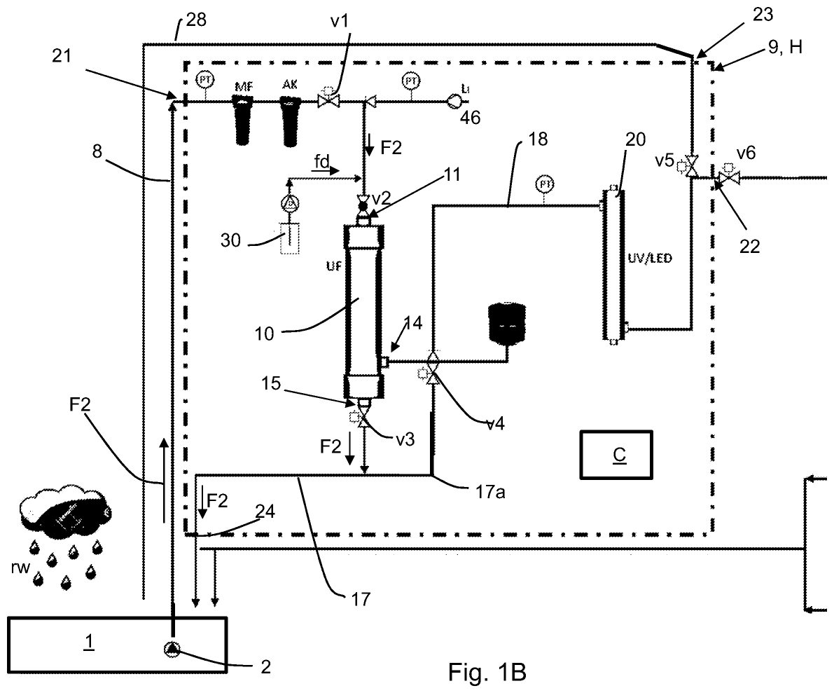

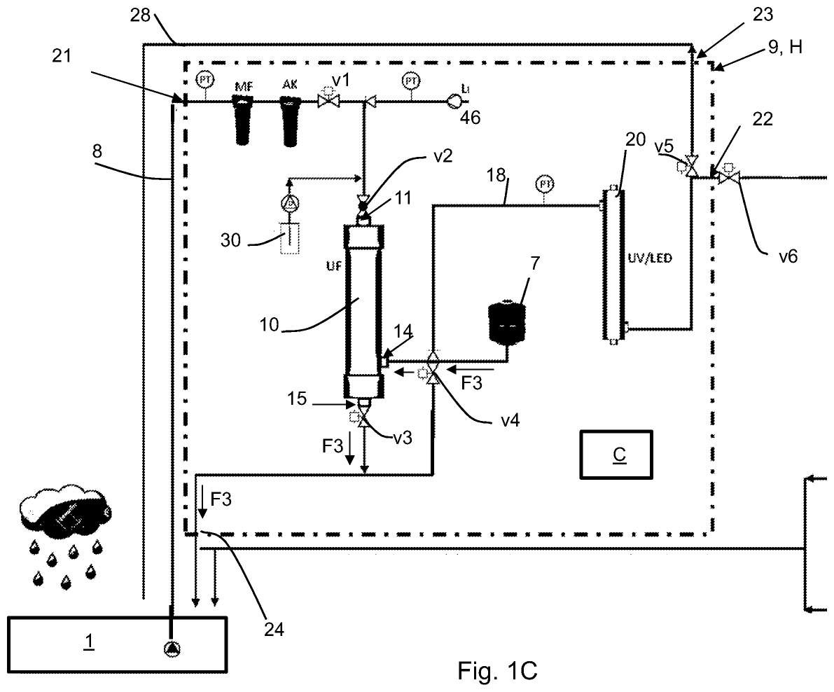

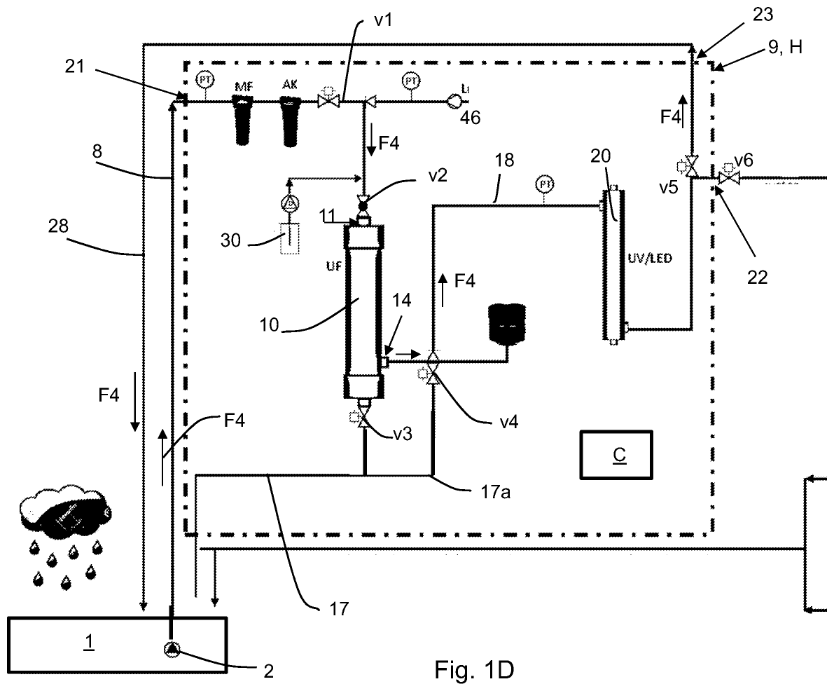

FIG. 1A schematically shows an example of a water treatment system, according to a first embodiment, during a water treatment phase;

FIG. 1B shows the first embodiment during a first filter treatment phase;

FIG. 1C shows the first embodiment during a second filter treatment phase;

FIG. 1D shows the first embodiment during a recirculation phase;

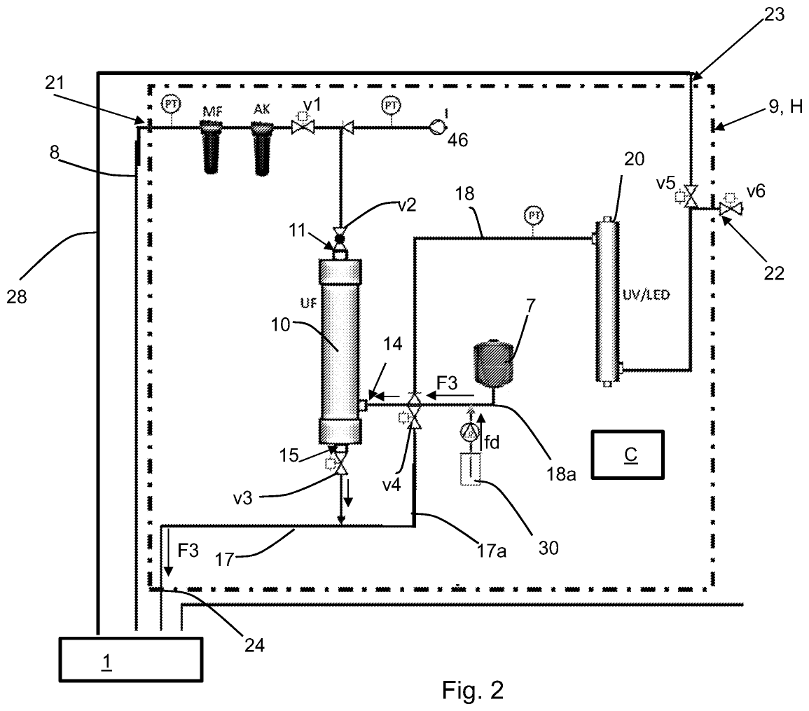

FIG. 2 is similar to FIGS. 1B, 1C, 1D, showing a second embodiment of a water treatment system;

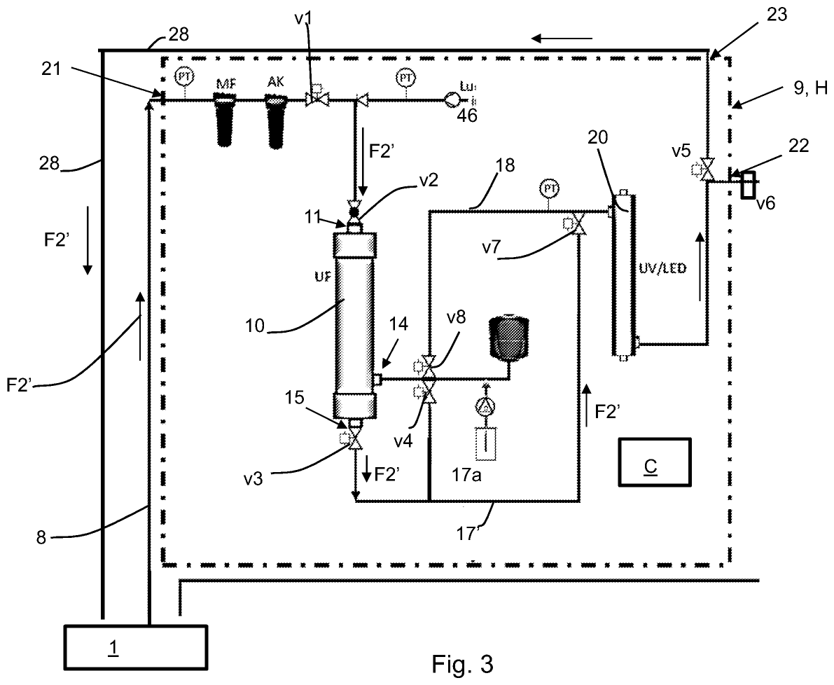

FIG. 3 is similar to FIGS. 1B, 1C, 1D, showing a third embodiment of a water treatment system;

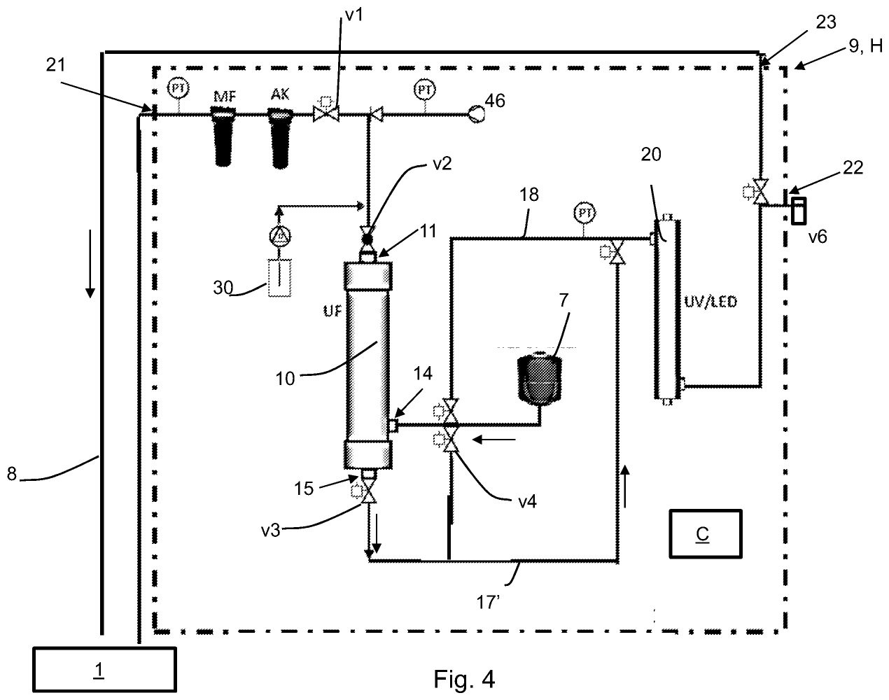

FIG. 4 is similar to FIGS. 1B, 1C, 1D, showing a fourth embodiment of a water treatment system;

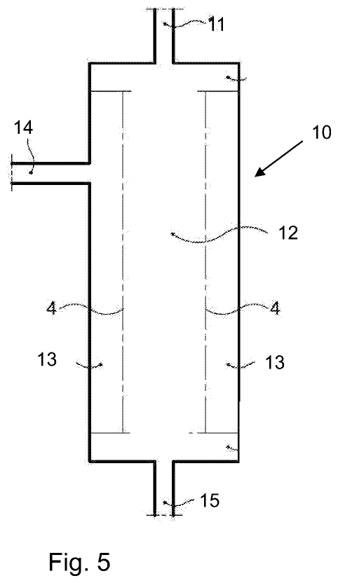

FIG. 5 schematically shows an example of a filter; and

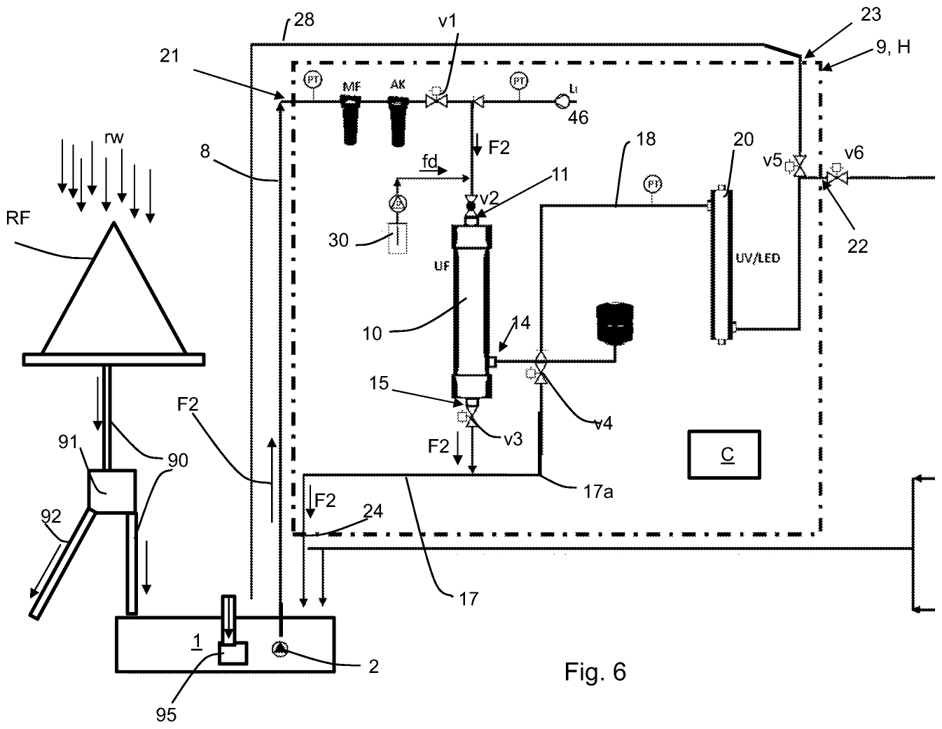

FIG. 6 is similar to FIGS. 1B, 1C, 1D, showing a further example of the system.

FIG. 1 depicts an example of a residential water treatment system. The system includes a rain water collector 1, a water treatment unit 9 (schematically indicated by a dashed box), and a pump 2 for pumping water from the rain water collector 1 to the water treatment unit 9 (e.g. to a water inlet port of that unit 9) via a water supply duct 8.

The rain water collector can e.g. be a water tank, for example a tank having a volume in the range of 5-50 m³, or differently. It may be located in or near a building (e.g. a residential building or an office), e.g. at least partly or fully above or below ground surface level, in or near a garden or the-like. It is preferred that the rain water collector 1 is located underground (i.e. out of sight). In a preferred embodiment, the rain water collector is connected to one or more rain water supply ducts (not shown), for feeding the collector with rain water rw that has fallen remotely from the collector 1, e.g. rain water that has been received on a roof RF of a building (see FIG. 6).

In a preferred embodiment, the rain water collector is (also) configured to received greywater, e.g. via a greywater discharge duct 25, as will be explained below.

The pump 2 can be installed in the rain water collector (e.g. below a water level in the collector), but that is not required. The water supply duct 8 can include one or more water duct sections as will be appreciated by the skilled person.

The water treatment unit 9 as such can e.g. be included in or provided by an assembled structure, for example having a carrying frame and/or housing H, to provide ease of transportation, delivery and efficient installing. Various components can be installed in (i.e. provided by) that unit 9, as follows from the following. It is preferred that the water treatment unit 9 as such is a relatively light-weight structure, so that it can be carried/lifted by a single person (the unit 9 as such e.g. having a mass of max. 30 kg).

The water treatment unit 9 can include an integrated water supply duct 16 that is connected to an external water supply duct 8 via the inlet port 21. Optionally, these supply ducts 8, 16 can be integrated with each other. Optionally, one or each of the water supply duct(s) 8, 16 can be provided with one or more water pre-filters 45, for example for filtering relatively large particles (e.g. sand particles, particles having a size of more than 1 micron), debris and/or leaves from supplied rain water (i.e. water that passes the respective duct 8, 16).

It should be observed that in case of a relatively large water collector 1, more that one water treatment unit 9 can be provided for receiving and treating rain water.

Preferably, the water treatment unit 9 includes an ultrafiltration unit 10. Ultrafiltration units (filters) as such are known to the skilled person. An example is depicted in FIG. 5, schematically in a cross-section. The ultrafiltration unit 10 includes a filtering space 12, a water collecting space 13 and a downstream filtered water outlet 14 (i.e. a first water outlet port 14), the filtering space 12 and collecting space 13 being separated by at least one porous wall 4, wherein the filtering space 12 extends between a water inlet port 11 and a second water outlet port 15.

During a water filtering phase, rain water is supplied via a said water supply duct 8, 16 and the water inlet port 11 to the water filtering space 12, wherein the water passes the porous wall 4, enters the collecting space 13 and leaves the filtered water outlet port 14. Such a filter operation is shown in FIG. 1A, wherein arrows F1 show a respective flow direction of water through the system (the water flow being achieved by pumping action of the pump 2).

During a normal filter flushing phase, filter flushing water (in particular rain water) is supplied via the water inlet port 11 to the water filtering space 12, wherein the flushing water leaves the second water outlet port 15, thereby rinsing the filtering space 13. Such a flushing is depicted in FIG. 1B; therein arrows F2 show a flow direction of water through the system (the water flow being achieved by pumping action of the pump 2).

During a filter backwash flushing phase, filter flushing water is supplied to the first water outlet port 14, wherein the water passes the porous wall 4 and leaves the filter unit 10 via the second water outlet port 15. Such a flushing is shown in FIG. 1C, wherein arrows F3 show a respective flow direction of water through the system. In this case, a water backwash flow can be achieved by action of an optional water pressure vessel 7 (as will be explained below) that can be located downstream with respect to the filter outlet port. Alternatively, an additional duct can be installed (not shown) for connecting the rain water supply duct 8 to the filter outlet port 15 so that the pump 2 can pump rain to that port 15 for a filter backwash (such an additional duct can e.g. include suitable controllable valve means for allowing water passage during filter backwash and blocking water passage during a normal water filter phase of the system).

In this way bacteria can be filtered effectively out of the supplied rain water, and a reliable filter operation can be achieved.

Optionally, the system (e.g. the water treatment unit 9) can include an air supply means 46, for example an air pump, for pressurizing at least part of the system using air (for example for carrying out an optional ultrafiltration unit leak test). The air supply means 46 can e.g. be connected to the water supply duct 16, wherein an optional non-return valve (check valve) w1 can be installed in-between to prevent water entering the air supply means 46.

The ultrafiltration unit 10 can be configured in various ways. For example, the ultrafiltration unit 10 can have a tubular construction. As will be appreciated by the skilled person, the porous wall 4 can be provided by one or more filter tubes, for example a bundle of filter tubes. The porous wall 4 can for instance provided with pores having a pore diameter size <1 μm, for example in the range of approximately 0.005-0.04 μm, more in particular in the range of approximately 0.01-0.03 μm.

More particularly, the ultrafiltration unit 10 may include a number of channels extending in longitudinal direction of the unit 10, the channels together providing the water filtering space 12. Only one such channel is shown in the present drawings. The one or more channels can be surrounded by the porous tube wall 4 (e.g. a tubular wall of a filter tube or tube section). The porous tube wall 4 separates the at least one filtering space 12 from the collecting space 13, in particular such that water, supplied via inlet 11 to said filtering space 12, is passed substantially bacteria free, via said porous tube wall 4 to said collecting space 13.

The porous tube wall 4 preferably includes a permeable membrane, for example made of polysulfone, pvc (polyvinyl chloride), pvdf (polyvinylidene difluoride), polyethersulfone or ceramic material.

Preferably, the system is configured for supplying at least approximately 10 liter/minute of filtered rain water, for example 20 to 30 liter/minute.

According to a preferred embodiment, the system includes at least one water treatment device 20, 30 for treating the flushing water. It is preferred that the or each water treatment device 20, 30 is part of or integrated in the water treatment unit 9.

For example, a water treatment device 20 can be configured for protecting the unit 10 for back growing of bacteria, and/or for irradiating the flushing water, for example by irradiation with UV (ultraviolet) light and/or LED (light emitting diode) light. Preferably, such a water irradiation device 20 is configured to irradiate passing water, such that the irradiation kills bacteria that may present in that water (i.e. the device 20 can disinfect the water that passes the device 20).

For example, a water irradiation device 20 can be arranged downstream of the second water outlet port 15 of the ultrafiltration unit 10.

It is preferred that the water treatment device 20, e.g. UV radiation source, is not operable during normal system operation (i.e. when the system filters water and/or discharges filtered water that meets end-user requirements), but is only present as a backup water treatment device 20, for example depending on a system integrity sensor measurement (e.g. of a sensor for detecting e.g. water quality of water emanating from the first water outlet port 14, or of a sensor for detecting integrity of the filter 10). For example, the system can include a controller C (see below) configured to activate the water treatment device 20 depending on at least one system parameter, in particular a system integrity parameter provided by a system integrity sensor. The treatment device 20 can e.g. be communicatively connected to such a controller C, e.g. via a wireless or wired signal link (not shown), to be controlled thereby, e.g. to be activated when the controller C detects a certain integrity problem (e.g. system failure, for example in case of detection of certain water contamination downstream of the filter unit 10 and/or of a failure of operation of the filter unit 10), using for example an integrity sensor detection result. The controller C can be configured to maintain the treatment device 20 in a disabled (non-operative) state in case the controller determines that the system, e.g. the filter unit 10, functions according to normal, desired, operating conditions and for example delivers filtered water that meets end-user requirements. In this way, by deactivating the treatment device 20 under normal system operating conditions, significant energy savings can be achieved, in particular in case the treatment device includes an UV-radiation source. The system integrity sensor can be configured in various ways, and can e.g. include a water pressure sensor that can e.g. signal system failure in case of a certain pressure drop in a system part. Alternatively or additionally, the system integrity sensor can be a water contaminant (pollution) detector that can be configured to signal system failure in case of detecting a threshold amount of one or more contaminants in the filtered water.

Also, for example, a water treatment device can include a doser 30 for dosing a water treatment substance to the flushing water. In that case it is preferred that the water treatment substance is a biofilm remover (known as such to the skilled person). It is preferred that the doser is integral part of the water treatment unit 9.

For example, the doser 30 can be located upstream with respect of the water inlet port 11 of the ultrafiltration unit 10 (see FIGS. 1A-1B, 4). FIGS. 2 and 3 show alternative configurations wherein the doser is located downstream of a or each water outlet port 14, 15 of the ultrafiltration 10, for dosing the water treatment substance during a filter backwash phase.

The doser 30 can e.g. include a reservoir that contains the substance to be dosed, the reservoir being connected to a water duct of the system for feeding predetermined amounts of the substance during respective substance dosing steps or dosing periods. The doser 30 can e.g. include a controllable valve and/or dosing pump for discharge of the substance. The substance can e.g. be held by the doser in a liquid form, a solid form (to be dissolved in the rain water), tablet form (to be dissolved in the rain water) or the like. The doser 30 can e.g. be communicatively connected to a controller C (see below), e.g. via a wireless or wired signal link (not shown), to be controlled thereby.

Referring to FIG. 1, the water treatment system can be associated with one or more end-users EU, for example one or more drinking water tap points, water consuming devices or the-like. The water treatment unit 9 can include at least one water outlet port 22 for supply of water to such end user(s) EU. For example, the system can include a filtered water outlet 22 for supplying water to at least one drinking water tap EU. The water treatment unit 9 can include a water discharge duct 18 for connecting the filtered water outlet 22 to the first water outlet port 14 of the ultrafiltration unit 10.

According to a preferred embodiment, the system is configured for feeding flushing water from the filtering space 12 to the rain water collector 1 (i.e. during a filter flushing phase). To this aim, as is shown in FIGS. 1B, 1C, there can be provided a flushing water discharge duct 17 (and e.g. a respective outlet port 24 of the water treatment unit 9), arranged to receive the flushing water from the filter unit 10 and for directly discharging that water (returning the water) to the rain water collector 1 (in in particular bypassing any end user greywater filters GA, GB). Thus, relatively long filter flushing/rinsing periods can be carried out, without substantial loss of water.

The flushing water discharge duct 17 can include or be connected to a bypass duct 17a, having a valve v4, the bypass duct 17a being connected to the filter outlet port 14 and/or water discharge duct 18 to provide a bypass if desired. This bypass can be used e.g. to disinfect the flushing water (using the irradiation device 20) first before feeding the flushing water back to the water collector 1 (similar to FIG. 3), in which case a distal section of the flushing water discharge duct 17 can e.g. include an additional valve (not shown) that can be closed (whereas valve v4 can be opened) to allow flushing water flow to the irradiation device 20.

Moreover, it is preferred that the system includes a first return duct 28 for returning filtered water from the collecting space 13 (of the ultrafiltration unit) to the rain water collector 1 (in particular directly, e.g. bypassing any end user greywater-filters GA, GB). For example, the water treatment unit 9 can include a separate return water outlet port 23 that is connectable to such a return duct 28, wherein the water discharge duct 18 of the water treatment unit 9 can be connectable to the return water outlet port 28. In this way, the system can provide an (additional) water circulation phase, as is shown in FIG. 1D. During water circulation, rain water is pumped (by the pump 2) to the water treatment unit 9, to be filtered thereby, wherein the treated water is not fed to the end user(s) EU but is returned to the rain water collector 1. It has been found that in this way, improved rain water treatment can be achieved, allowing relatively long system operational periods and relatively system low maintenance requirements.

In a preferred embodiment, the first return duct 28 is arranged downstream of the or each water treatment device 20, 30. Thus, for example, water that is returned to the water collector 1 (during a circulation phase) can be treated by one or each of these water treatment devices 20, 30. Also, in an embodiment, the first return duct 28 can be arranged upstream of an end user outlet port 22 (i.e. upstream of end users EU), so that the water can be returned separately from the end users. In a preferred embodiment, the system is configured to irradiate the water that is returned via the first return duct 28, in particular utilizing a said a water irradiation device 20 (by activating such a device during water circulation). Optionally, the returned water (returned to the water collector 1) can include at least part of a dosed substance that is dosed by the (optional) dosing device 30.

According to an embodiment, the system (e.g. water treatment unit) includes a number of controllable valve means v1, v2, v3, v4, v5, v6 for controlling water flow, in particular to and/or from the ultrafiltration unit 2. Each such valve means can be configured in various ways, and can e.g. include a 2-way or 3-way valve, a solenoid valve, or the-like. Each of the valve means is preferably configured to be controlled using an electric or electronic control signal (but that is not required). Additionally or alternatively, each of the valve means can be hand controllable.

For example, a first valve means v1 can be arranged in or at the water inlet duct for controlling (e.g. allowing or preventing, depending of the valve state) waterflow through that duct 8. In an example, the first valve means v1 are arranged between the water inlet port 21 of the water treatment unit 9 and the inlet port 11 of the ultrafiltration unit 10. The first valve means v1 can be arranged downstream with an or each optional pre-filter 45. In an example, the first valve v1 means can be arranged upstream with respect to a doser 30 for feeding a said substance to the rain water.

For example, a second valve means v2 can be arranged in or at the water inlet port 11 of the ultrafiltration unit 10 itself, for controlling (e.g. allowing or preventing, depending of the valve state) waterflow through that port 11.

For example, a third valve means v3 can be arranged in or at the flushing port 15 of the ultrafiltration unit 10 itself, for controlling (e.g. allowing or preventing, depending of the valve state) waterflow through that port 15.

For example, a fourth valve means v4 can be arranged in or at the filtered water discharge port 14 of the ultrafiltration unit 10 itself, e.g. for controlling (e.g. allowing or preventing, depending of the valve state) waterflow through that port 14.

For example, a fifth valve means v5 can be arranged in or at a return water outlet port 23 of the water treatment unit 9, e.g. for controlling (e.g. allowing or preventing, depending of the valve state) waterflow through that port 23 back to the rain water collector 1.

For example, a sixth valve means v6 can be arranged in or at a filtered water outlet port 22 of the water treatment unit 9, e.g. for controlling (e.g. allowing or preventing, depending of the valve state) waterflow through that port 22, towards one or more end user(s) EU.

Similarly, it is preferred that the system (e.g. the water treatment unit) includes a controller C for controlling these valve means v1-v6. The controller can e.g. be provided by suitable hardware and/or software, microelectronics, a computer or microcontroller or the like, and can be communicatively connected (e.g. via one or more wired and/or wireless signal lines, not shown) to the valve means to control the valves (e.g. using suitable control signals). Also, the controller C can be configured for controlling the pump 2 (i.e. for activating and deactivating the pump) utilizing suitable pump control signals and a suitable signal communication link (not shown) between the pump 2 and the controller C. It is preferred that the controller C is (integral) part of the water treatment unit 9.

The controller C can e.g. be configured for automatically initiating (and halting) a water filtering phase by adjusting the valve means to allow (and halt) a flow of flushing water to the ultrafiltration unit 2, and from that unit to one or more downstream end users EU.

The controller C can e.g. be configured for automatically initiating (and halting) a filter flushing phase by adjusting the valve means to allow (and halt) a flow of flushing water to the ultrafiltration unit 2.

The controller C can e.g. be configured for automatically initiating (and halting) a water recirculation phase, by adjusting the valve means to allow (and halt) a flow of water to the ultrafiltration unit 2 and back via the return duct 28 to the rain water collector 1.

The controller C can e.g. be configured for automatically initiating (and halting) a substance dosing phase/step filtering phase by controlling the doser 30 to dose the substance to the water. A dosing flow (e.g. a discharge of an amount of dosing substance into the rain water, by the doser 30) is indicated by arrow fd in FIG. 1B.

The controller C can e.g. be configured for automatically initiating (and halting) an airpump 46 for an integrity test of the porous tube wall 4 of the membrane(s) in the filter unit 10. This integrity test can e.g. be used for controlling operation of the optional water treatment unit 20 (as described above), wherein the water treatment unit 20 is only activated in case the integrity test leads to a negative outcome (i.e. filter failure).

According to a preferred embodiment, there can be provided a pressure vessel 7 for pressurizing the flushing water. The pressure vessel 7 can be part of or integrated with the water treatment unit 9. In particular, the pressure vessel 7 can be arranged to provide flushing water to the ultrafiltration unit 10 during a respective filter flushing phase, wherein it is preferred that the respective flushing is a filter backflush (i.e. by supplying the water to the outlet port 14 of the filter, see FIG. 1C). To that aim, for example, the pressure vessel 7 can be arranged downstream with respect to the outlet port 14. The pressure vessel 7 can be connected to a said filtered water discharge duct 18. A non-return valve (check valve) w2 can be installed for preventing water flowing from the discharge duct 18 to the pressure vessel 7 (in an example, the non-return valve w2 is arranged between the pressure vessel 7 and a water treatment device 20 of the discharge duct 18.

Pressure vessels as such are commonly known to the skilled person (it can be a so called “expansion vessel”). The pressure vessel 7 as such can be arranged to be pressurized during a vessel pressurization phase, including feeding water into the vessel. The vessel can include a spring means, e.g. diaphragm or bladder, that is elastically deformed by the water fed into the vessel. When external water pressure drops, the pressure vessel releases water upon spring action of the integrated spring means (e.g. an integrated bladder or diaphragm relaxing from a deformed condition).

Advantageously, the pressure vessel 7 can be arranged to be pressurized by the pump 2. For example, a pressure vessel pressurization phase can including the pump 2 pumping water to the water treatment unit 9, wherein the water is guided via integrated duct sections of the unit to the pressure vessel 7. In order to pressurize the vessel 7, for example, one or more duct sections downstream of the vessel 7 can be closed by respective one or more valves v3, v4, v5, allowing pressurization of the discharge duct 18 to which the pressure vessel 7 can be connected. After such a pressurization phase, the pump 2 can e.g. be deactivated, wherein one or more valves v2, v3 of the water treatment unit 9 can be controlled to allow a backwash of the ultrafiltration unit 10 via water discharge from the pressure vessel 7 (this is shown in FIG. 1C).

The controller can e.g. be configured for automatically initiating (and halting) a pressure vessel pressurization phase by adjusting the valve means to allow pressurization of a duct 18 that is connected to the pressure vessel 7. For example, the controller can be configured to initiate a pressure vessel pressurizing phase by closing valve means v3 downstream of the pressure vessel 7.

The controller can e.g. be configured for automatically initiating (and halting) a filter backwash phase by adjusting the valve means to allow (and halt) a flow of flushing water to the ultrafiltration unit 10, in particularly by allowing relaxation of the pressure vessel 7 (i.e. the vessel decompressing by discharging water to the ultrafiltration unit 10).

The controller C may be configured for carrying out a method according to the invention. For example, the controller can be configured to initiate one of the afore-mentioned phases (i.e. water filtering phase, filter flushing phase, circulation phase, a substance dosing step by the doser 30, membrane integrity testing), at one or more predetermined times, periodically, and/or based on a user operating an activation switch, user interface or other suitable user control member if available.

For example, the controller C can be configured to initiate a filter flushing phase and/or a filter backwash phase, at least once, or better, regularly, for example monthly, weekly, or before and/or after every working day or one or several times a day.

Also, it is preferred that the controller C is be configured to initiate a substance dosing phase (by the doser 30) at least once, or better, regularly, for example monthly, weekly, or before and/or after every working day or one or several times a day.

Moreover, it is preferred that the controller C is configured to initiate a substance dosing phase (just) before initiating a initiate a filter flushing phase and/or a filter backwash phase. For example, the controller can initiate the substance dosing phase, so that the doser discharges the substance into the water, after which a predetermined time is allowed for the substance to act in the ultrafiltration unit 10 (e.g. to remove biofilm from the porous wall 4). The predetermined time period can e.g. be in the range of 1 to 60 minutes, or 1 to 24 hours, preferably at most 4 hours, or a different time period. In an embodiment, the controller C can be configured to effect a water flow in the system (e.g. by temporarily activating the pump 2 and by setting system valves in suitable valve states) for transporting discharged substance from the doser 30 into the filter unit 10. The controller can be configured to initiate a filter flushing phase and/or backwash phase after the predetermined time period, to remove the substance from the filter unit 10, and e.g. to discharge the substance into the rain water collector 1. It is preferred that the amount of dosed substance is relatively low, in particular with respect to the volume of the rain water collector 1, so that its presence in drinking water at end users EU (during a drinking water filtering phase) is substantially neglectable and remains within desired drinking water tolerances.

Further, the system can include one or more pressure sensors PT for measuring water pressure in the system (in particular in a respective duct that has or contains the pressure sensor PT). One or more of these pressure sensors PT can be communicatively connected to the controller C to provide respective pressure measurement data or signals to the controller, e.g. via wired or wireless communication links (not shown). The controller C can be configured to process such pressure measurement data or signals, e.g. to control operation of the pump 2 (wherein the controller C can e.g. activate the pump 2 in case pressure at a certain point in the system drops below a certain, predetermined, first—low—pressure level, and/or wherein the controller C can deactivate then pump 2 in case pressure at a certain point in the system exceeds a certain, predetermined, second—high—pressure level; also, for example, the controller C can be configured to generate an alarm signal in case a detected pressure falls outside a desired pressure range).

According to a further embodiment, the rain water collector 1 can include at least one water inlet 29 for receiving greywater, in particular water that has been used domestically, i.e. by one or more end users EU that are connected to the water outlet 22 of the water treatment unit 9. In the example, there is provide a greywater return duct 25 for feeding such greywater back to the water collector (a return flow of such greywater is indicated by an arrow Fgw in FIG. 1). In this way, water loss can be kept at a very low level, and a substantially closed rain water usage system can be achieved.

Optionally, there can be provided one or more greywater filter means GA, GB for filtering the greywater before it is returned to the rain water collector 1. Such filter means GA, GB can include e.g. a constructed wetland filter GA (known as such, see https://en.wikipedia.org/wiki/Constructed_wetland) and an onsite sewage facilitie (OSSF) GB, also called septic system (see https://en.wikipedia.ord/wiki/Onsite_sewage_facility). Such one or more optional filter means GA, GB can e.g. be installed as part of the greywater return duct 25, or connected thereto, as will be appreciated by the skilled person (see FIG. 1A).

Use of the system can include a method for treating rain water, the method for example, the method including:
collecting rain water, in the rain water collector 1;
filtering collected rain water, by the ultrafiltration unit 10 during a water filtering phase;
flushing the ultrafiltration unit 10 with flushing water during a flushing phase; and
feeding the flushing water to the rain water collector 1.

In an embodiment, the flushing water can be (the) rain water.

In an embodiment, the flushing is a backflush of the ultrafiltration unit 10.

It is preferred that the method including treating the flushing water, for example by irradiation (via the irradiation device 20) and/or e.g. by dosing a biofilm remover to the water (buy the doser 30).

Preferably, the method includes a water circulation phase, of returning water filtered by the ultrafiltration unit 10 (directly) back to the rain water collector 1, preferably periodically and for example without use of the water by a domestic end user.

More particularly, FIG. 1A shows, with arrows F1, water flow through the system and respective water treatment unit 9 during normal rain water usage. The controller C can e.g. initiate such a water flow, e.g. based on water pressure at at least one measuring point (i.e. as provided by a pressure sensor PT) in the respective duct system, and/or pressure in or at the treated rain water discharge port 22 can be kept at a predetermined pressure (e.g. a pressure higher than 1 bar and lower than 6 bar, in particular a pressure in the range of about 2-4 bar). In an embodiment, the latter pressure can e.g. be measured by a pressure sensor PT locate at that port, and/or a sensor upstream (in the water treatment unit 9) e.g. at or near a water irradiation device 20 (if any). A valve v6 at the outlet port 22 is in an opened state during such a water consumption state.

During normal rain water usage (see FIG. 1A), the supplied rain water is filtered by the ultrafiltration unit 10. One or more optional prefilters 45 (e.g. a microfiltration filter and an activated carbon filter) can filter the water before it enters the ultrafiltration unit 10. Preferably downstream of the ultrafiltration unit 10, the filtered rain water is irradiated (by the irradiation device 20), to be discharged via the water outlet 22.

Water that is used by one or more end users EU, i.e. greywater, can optionally be filtered by the one or more greywater filters GB and can be returned to the rain water collector 1 so that it can be used again.

FIG. 1B shows a second mode of system operation, in particular a filter rinsing/flushing mode. During this phase, as is indicated by arrows F2 that show the respective flow direction of the flushing rain water, the ultrafiltration unit 10 (in particular its filter space 12) is flushed with rain water, the water entering the inlet port 11 and exiting the second outlet port 15, wherein the rain water is returned from the ultrafiltration unit (via water duct 17 and outlet port 24) directly to the rain water collector 1. Respective water flow can be achieved by pump activation. In this way, substantially no water is lost during the filter rinsing. For example, bacteria accumulated in the filtering space 12 of the filter unit 10 can be discharged into the rain water collector 1. The skilled person will appreciate that various valves v4, v5, v6 of the system can be in a closed state, and various valves v1, v2, v3 can be in an opened state, to allow the respective water flow F2.

FIG. 1C shows a third mode of system operation, in particular a filter backwash mode. During this phase, as is indicated by arrows F3 that show the flow direction of the rain water, the ultrafiltration unit 10 in particular its filter space 12 and also the collecting space 13) is backwashed with filtered rain water, by feeding the water into the outlet port 14 of the filter unit 10, the water exiting the unit 10 via the second outlet port 15, wherein the rain water is returned from the ultrafiltration unit (via water duct 17) directly to the rain water collector 1. Again, in this way, substantially no water is lost during the filter rinsing. It is preferred that the backwash is achieved by decompression of the pressure vessel 7. The skilled person will appreciate that various valves v2, v4, v5, v6 of the system can be in a closed state, and at least a valve v3 at the filter outlet 15 can be in an opened state, to allow the respective water flow F3.

Regarding a filter backwash phase, it is preferred that the pressure vessel 7 is (automatically) pressurized before the backwash phase to provide (sufficient) backwash water. To this aim, for example, water in a respective duct (for example a return duct 17 and/or a discharge duct 18) that is or can be brought in fluid communication with vessel 7, can be pressurized or maintained at a certain pressure. As an example, the pressure can be a normal system water pressure (e.g. a pressure of at least 2 bar, e.g. in the range of about 2 to 4 bar) that is maintained (e.g. by the pump 2) during a normal water filtering phase.

At the start of a filter backwash phase, valve states can be changed, such that the inlet port 11 of the filter unit 10 is closed, and the second outlet port 15 is opened (the first outlet port 14 also being opened), allowing local pressure vessel 7 decompression via the filter unit 10 towards the rain water collector 1 (and in this case via the return duct 17, a respective valve v4 in that duct 17 in a bypass section 17a between the second outlet port 15 and the discharge duct 18, being closed as well to insure proper water flow direction F3). If desired, the filter backwash phase can be repeated one or several times by pressurizing the vessel (using suitable valve settings and activating the pump 2) and subsequently decompressing the vessel (again by using suitable valve settings to provide such decompression).

FIG. 1D shows a fourth mode of system operation, in particular a water (re)circulation mode. During this phase, as is indicated by arrows F4 that show the flow direction of the rain water, the ultrafiltration unit 10 is used to filter the supplied rain water, wherein preferably the filtered water is irradiated or treated by a downstream irradiation device 20 (to further decontaminate the water, or at least kill bacteria present in the water). The thus treated rain water is returned from the water treatment unit (via water duct 28) to the rain water collector 1. Again, in this way, substantially no water is lost, wherein the rain water present in the water collector 1 can be treated to enhance water quality. The pump 2 can be active to provide the water circulation. Again, the skilled person will appreciate that various valves v1, v2, v5 of the system can be in a opened state, and various valves v3, v4, v6 can be closed to allow the respective water flow F4.

An alternative water circulation phase can involve bypassing the outlet port 22 of the water treatment unit 9 (and the discharge duct 18) by opening the bypass duct section 17a (by opening the valve v4 leading into the bypass duct section 17a), such that filtered water can leave the filter unit 10 to be discharged via the return duct 17 directly towards the rain water collector 1.

In any of the above modes of operation, and/or between such modes of operation, the doser 30 can be activated to feed a certain amount of water treatment substance into the system. As is mentioned before, it is preferred that the substance is dosed into a duct (e.g. water inlet duct 16) and is fed into the ultrafiltration unit 10, after which water flow is halted so that the substance can treat the ultrafiltration unit 10 (e.g. prevent the formation of biofilm and/or remove biofilm from the filter). A treated filter content is preferably discharged into the rain water collector 1, e.g. via a said filter backwash (FIG. 1C) and/or filter flush (FIG. 1B) and/or a rain water circulation (FIG. 1D).

Also, optionally, use of the system can involve an air pressurization step, including pumping air into the system, by optional airpump 46, e.g. for pressure and/or leakage testing (wherein a respective pressure sensor PT can e.g. be used to monitor pressure in at least part of the duct network). Such a system integrity testing step can e.g. be carried out as part of a system installation process, or e.g. during a certain system idle mode (when no filtered water is required by the end user(s) EU and when no filter washing/rinsing is carried out).

FIG. 2 depicts part of a system that is similar to the system of FIG. 1. A difference is that the substance doser 30 is located downstream of the outlet 14 of the ultrafiltration unit 10, in particular between that outlet 14 and the pressure vessel 7, to feed dosing substance to the respective duct section 18a. In this case, dosed substance can be fed into the unit 10 during a backwash phase (indicated by arrows F3). Operation of this alternative embodiment can follow the above-mentioned options and modes of operation concerning the system shown in FIGS. 1A-1D, wherein it is preferred that the pressure vessel 7 is used to provide a water flow to supply a dosed treatment substance into the ultrafiltration unit 10.

FIG. 3 depicts part of a system that is similar to the system of FIGS. 1 and 2. A difference is that it includes an alternative flushing water discharge duct 17′, that leads to an inlet of the first water treatment device (i.e. a water irradiation device) 20. The flushing water discharge duct 17′ preferably has a valve v7, preferably being controllably by the central controller C, which can be in a closed state during normal water filtering mode (to supply filtered water via the water outlet 22 to one or more end users) and in an opened state during a filter flushing (or backwashing) mode. A respective waterflow during a filter flush is indicated by arrows F2′ in FIG. 3. Optionally, a further controllable valve v8 can be installed in a discharge duct 18 extending between the outlet port 14 of the filter unit 10 and the flushing water discharge duct 17′ (e.g. instead of a return valve w2). In this case, preferably, all filter flushing and/or backwashing water is fed through the first water treatment device 20 and is treated thereby (during a respective flushing and/or backwash phase), before being discharged and returned (via return duct 28) to the rain water collector 1. In this way a relatively compact system can be achieved, requiring e.g. only one return duct 28 for water circulation and return of filter treatment water, and allowing treatment (of any discharged water) by the second water treatment device 20 before the water ism fed back to the water collector 1.

FIG. 4 shows an embodiment that is similar to the embodiment of FIG. 3, wherein the position of the substance doser 30 has been altered. In FIG. 4, the doser 30 is positioned upstream of the water inlet of the ultrafiltration unit 10, at a respective water supply duct 8.

The above embodiments can deliver filtered rain water (via a water outlet 22) to one or more end users EU, the water in particular being drinking water (i.e. water that is safe to be consumed by humans), the water in particular being free of bacteria (e.g. fee of Collie-bacteria, Streptococcus as well as Legionella bacteria).

In case of use of a biofilm removing substance (in particular for treating the ultrafiltration unit), it has been found that filter backwash periods can be significantly reduced, allowing longer system operational periods for delivering filtered rain water. It is believed that the biofilm removing substance can reduce or prevent clogging of the filterwall(s) 4 of the ultrafiltration unit, so that a backwash can be carried out swiftly, efficiently and effectively. Besides, discharged biofilm material can be fed back to the rain water collector 1.

While the invention has been explained using exemplary embodiments and drawings, these are not to be construed as in any way limiting the scope of the invention, which scope is provided by the claims. Many variations, combinations and extensions are possible, as will be appreciated by the skilled person. Examples thereof have been provided throughout the description. The term “a” should be interpreted broadly since it can mean “at least one” and is not limited to “a single”. For example, “a duct” can include one or more ducts, a network of ducts or the like as will be appreciated by the skilled person. Also, the ultrafiltration unit can include a single porous wall or a plurality of porous walls for filtering the rain water. A said water duct can e.g. include one or more conduits, pipes, water communication lines and/or the-like, for passing (liquid) water between respective system components.

In this application, a connection between water ducts in particular means that the ducts are in fluid connection (allowing passage of water), as will be clear to the skilled person.

The term “residential” should be interpreted broadly, since it can include or concern any place, location, building, office, shop, restaurant or structure where at least one drinking water tap is present for providing potable (drinking) water to humans (for human consumption) and/or to water consuming devices or systems. For example, the system and method according to the invention can be installed or used on-shore or off-shore (e.g. on a ship or vessel).

A “system phase” can be a “system mode”, or mode of operation, or e.g. an operational (time) period, or the-like, wherein for example one or more actions are carried out by the system. Certain system phases may at least partly overlap with each other (for example, circulation of water via a water return duct 28 can be carried out simultaneously with feeding water to one or more end users).

Thus, the term “Residential water treatment system” can also be called a “drinking water providing system”.

Also, as will be appreciated by the skilled person, “rain water” can include rain water that is received directly by the water collector, and/or rain water that is received indirectly by the water collector (for example rain water that is fed to the rain water collector, e.g. via a suitable rain water feeding channel/conduit). The rain water can be water from rain that has fallen locally, near the rain water collector (e.g. within 100 m from the collector), but that is not required.

For example, in case of a dosing Biofilm remover substance it is preferred that the substance is or includes a composition provided for removing biofilm from, and/or preventing biofilm from forming on, a surface in a water system, the substance comprising an aqueous solution of:
(a) 13.3-20.0 g/L metasilicate;
(b) 13.3-16.7 g/L carbonate;
(c) 3.3-6.7 g/L gluconate;
(d) 3.3-6.7 g/L potassium aluminium sulfate.

It has been found that such a substance can provide good Biofilm removal.

Also, the dosing substance can be or contain one or more salts, e.g., sea salts, and/or other additives.

It is preferred that the dosing substance does not produce or comprise a peroxide, a terpene or sodium hypochlorite. It is preferred that the dosing substance does not contain a chemical desinfactant aimed at killing bacteria. It is preferred that a Biofilm remover is aimed at weakening a bond between the biofilm and the porous wall 4 of the ultrafiltration unit, in particular by charging the wall 4 (thereby forcing positively charged Biofilm away from the wall 4).

Also, the water treatment unit 9 can include various types of water treatment devices and (pre-)filters. For example, instead of a said treatment device 20 or pre-filter 45, or in addition thereto, the unit 9 can include an activated carbon filter and/or a microfiltration filter, a zeolite based water treatment device. The ultrafiltration unit 10 can be or include a nanofilter (to provide nanofiltration of the rain water).

Also, according to an example, the system can be configured to allow remote system monitoring. To that aim, for example, the controller C can be provided with or connected to communication means to connect the controller C to a remote server or a remote user terminal (e.g. via a computer network, Internet, an intranet or the like), to exchange system status data and/or system controlling instructions, warning messages (if any) and the-like.

The skilled person will appreciated that various system components can be arranged in various mutual positions; for example, an irradiation filter 20 can be located upstream or downstream of a filtration unit 10. Also, for example, one irradiation filter can be positioned upstream of the filtration unit 10, and another irradiation filter 20 can be located downstream of the filtration unit 10. The same holds for the more water pre-filters 45.

Besides, for example, the system can be configured to provide a first flush, as is schematically depicted in FIG. 6. Therein, at the start of a rain shower, the rain water rw can be first collected on a roof RF of a building. In this case, the rain water collector 1 is arranged downstream of the roof RF, wherein one or more rain water supply ducts 90 are available for feeding the collector 1 with the rain water rw that has fallen on the roof. Then, it is preferred that at least one bypass valve 91 is installed in the duct(s) 90 between the roof RF and the collector 1, wherein the valve has a first valve state for bypassing the collector 1 during a first stage, e.g. an initial stage after a start of the rain shower, via a bypass duct 92. The bypass duct 92 can e.g. initially discharge the water to another location (e.g. a sewer system, a canal or a field), remote from the collector. In this way, roof sections and downstream ducts can be flushed (cleansed) using the initially received rain water, the valve 91 preventing such water to reach the collector 1. After a predetermined flush time period, and/or after a predetermined amount of rain water has passed e.g. the bypass valve 91 (towards the bypass duct 92), the valve 91 can be adjusted to a second valve state to provide a collector filling phase wherein the rainwater rw is led from the roof RF via the intermediate duct(s) 90 into the rain water collector 1, for filling the collector 1. Optionally, the bypass valve 91 can be controllable by the system controller C, for example using a control signal transmitted via a wireless or wired connection from the controller C to the valve.

Besides, for example, the system can be configured to provide aeration of rain water in the collector 1. This is schematically depicted in FIG. 6. To that aim, a water aerator 95 (e.g. having an air pump) can be provided, for feeding (in particular actively pumping) ambient air into water that is present in the collector 1. It has been found that in this way, improved water quality can be achieved, in particular concerning pH values, ammonium, nitrite, and heavy metals (e.g. zinc).

1. A water treatment system, including:
a rain water collector, a water treatment unit, and a pump for pumping water from the rain water collector to the water treatment unit via a water duct, wherein the water treatment unit includes:
an ultrafiltration unit including a filtering space, a water collecting space and a downstream filtered water outlet, the filtering space and collecting space being separated by a porous wall, wherein the filtering space extends between a water inlet port and a water outlet port for supplying water to the filtering space during a water filtering phase and for flushing the filtering space during a flushing phase;
wherein the system is configured for feeding flushing water from the filtering space to the rain water collector during a filter flushing phase.

2. The system according to claim 1, including at least one water treatment device for treating the flushing water.

3. The system according to claim 2, wherein the water treatment device is configured for irradiating the flushing water.

4. The system according to claim 2, wherein the water treatment device includes a doser for dosing a water treatment substance to the flushing water.

5. The system according to claim 1, including a first return duct for returning filtered water from the collecting space to the rain water collector.

6. The system according to claim 5, including at least one water treatment device for treating the flushing water, and wherein the first return duct is arranged downstream of the water treatment device.

7. The system according to claim 1, including a pressure vessel for pressurizing the flushing water.

8. The system according to claim 7, wherein the pressure vessel is arranged to be pressurized by said pump.

9. The system according to, including controllable valve for controlling water flow to and/or from the ultrafiltration unit, and a controller for controlling the valve.

10. The system according to claim 9, wherein the controller is configured for initiating and halting a pressure vessel pressurizing phase by closing the valve downstream of the pressure vessel.

11. The system according to claim 1, wherein the rain water collector is a water tank.

12. The system according to claim 1, wherein the system includes a filtered water outlet for supplying water to at least one drinking water tap.

13. The system according to claim 1, wherein the rain water collector includes at least one water inlet for receiving greywater.

14. A water treatment unit of the system according to claim 1, wherein the water treatment unit is included in an assembled structure.

15. A method for treating rain water, the method including:
collecting rain water, in a rain water collector;
filtering collected rain water, by one or several filters, during a water filtering phase;
flushing the one or several filters with flushing water during a flushing phase;
feeding the flushing water to the rain water collector.

16. The method according to claim 15, wherein the flushing water is rain water.

17. The method according to claim 15, wherein the flushing is a backflush of the one or several filters.

18. The method according to claim 15, including treating the flushing water.

19. The method according to claim 15, including returning water filtered by the one or more filters back to the rain water collector.

20. The method according to claim 15, including: providing a water treatment device downstream of the one or several filters, wherein the water treatment device is not operable during normal filter operation, wherein the treatment device is automatically activated in case a system failure is detected.

21. The system according to claim 1, including a water treatment device downstream of the filtered water outlet of the filter unit, wherein the system includes a controller configured to activate the water treatment device depending on at least one system parameter.

22. The system according to claim 1, wherein the system includes an aerator for feeding air into the rain water collector.

23. The system according to claim 1, including a roof for collecting rain water, an intermediate duct system for feeding collected rain water to the rain water collector, wherein the intermediate duct system includes a bypass valve that has a first valve state for blocking passage of water via the intermediate duct system to the rain water collector and a second valve state for allowing passage of water via de intermediate duct system to the rain water collector.
